(19) United States
(12) Patent Application Publication
(10) Pub. No.: US 2019/0132600 A1
(43) Pub. Date: May 2, 2019

(54) METHOD AND APPARATUS FOR ENCODING/DECODING A SCALAR INTEGER INTO A PARAMETER REPRESENTATIVE OF A PIVOT POINTS OF A PIECE-WISE LINEAR FUNCTION

(71) Applicant: THOMSON LICENSING, Issy-les-Moulineaux (FR)

(72) Inventors: Edouard FRANCOIS, Bourg des Comptes (FR); Patrick LOPEZ, Livré sur Changeon (FR); Yannick OLIVIER, Thorigné Fouillard (FR)

(21) Appl. No.: 16/098,858

(22) PCT Filed: Apr. 26, 2017
(86) PCT No.: PCT/EP2017/059850

§ 371 Date: Nov. 4, 2018

(30) Foreign Application Priority Data
May 4, 2016 (EP) 16305524.7

(51) Int. Cl. H04N 19/30; H04N 19/98; G06F 17/13; H04N 19/136; H04N 19/186; H04N 19/172

(52) U.S. Cl. CPC H04N 19/30; H04N 19/98; H04N 19/172; H04N 19/136; H04N 19/186; G06F 17/13

(57) ABSTRACT

A method for encoding and decoding, a scalar integer into at least one parameter representative of a pivot point comprised in a set of pivot points representative of a piece-wise linear function, said scalar integer being used when modifying pixel values of a picture, and corresponding apparatus, are disclosed. Said encoding method comprises:—a step E1 of selecting a subset of pivot points from the set of pivot points, according to a criterion, said subset comprising a number M of pivot points less than the number N of pivot points of said set of pivot points, —at least one step of coding E2 one bit of a binary representation of said scalar integer in a least significant bit of a component of a pivot point comprised into said subset.

### 1. TECHNICAL FIELD

The present disclosure generally relates to data hiding method and to picture/video encoding and decoding. Particularly, but not exclusively, the technical field of the present disclosure is related to encoding/decoding of a picture whose pixels values belong to a high-dynamic range.

### 2. BACKGROUND ART

It is known to hide a scalar integer V in a set of coded values C[i], for i=0 to N−1, so as to avoid the coding cost of the scalar integer V. A data hiding method is to use the least-significant bit (LSB) of the coded values to hide the scalar integer V.

As an example, the scalar integer V is represented in a binary form by a set bits b[k], with k=0 to K−1, K being the bit depth used to code V, i.e. the number of bits necessary to code the scalar integer V. The bits b[k] of V are hidden as follows:

if b[k] is equal to 1, then C[k] is forced to be odd, i.e. the LSB of C[k] is set to 1,
else C[k] is forced to be even, i.e. the LSB of C[k] is set to 0.

At the decoder side, the value V is reconstructed as follows: V is initially set to 0, and for i=0 to K−1, V=2*V+(C[i] %2).

When the coded values C[i] are transmitted to a decoder apparatus, the bits of the binary representation of the scalar integer V are then retrieved from the received coded values and the scalar integer V is reconstructed.

With such a data hiding method, the coded values in which the value V is hidden are modified from the original coded values. Using the LSB method, a one-bit precision for the coded values is lost. Therefore, such a method may impact the reconstruction quality of the coded values.

When such a data hiding method is used to hide a scalar integer V into a set of coded values representing pivot points representative of a piece-wise linear function, such pivot points may be slightly modified, leading to reconstruction errors of the function. Such reconstruction errors of the function could impact the reconstruction of other datas which use the piece-wise linear function.

For example, FIG. 11 illustrates a piece-wise linear function with 6 pivot points. As an example, such a piece-wise linear function could be used to adjust a modeled function used for High Dynamic Range (HDR) image reconstruction.

There is thus a need for an encoding method of a scalar integer into a set of coded values that preserves the properties of a piece-wise linear function represented by the coded values.

A piece-wise linear function has specific properties. In particular, the first and last points of such a function are sensitive. Furthermore, in the example of HDR image reconstruction cited above, the adjustment function has a flatter shape in the end than in the beginning. Therefore, a reconstruction error at the beginning may have a greater impact on the modeled function than at the end of the shape.

### 3. SUMMARY

According to an aspect of the present principle, a method for encoding a scalar integer into at least one parameter representative of a pivot point comprised in a set of pivot points representative of a piece-wise linear function. Said method comprising:
a step of selecting a subset of pivot points from the set of pivot points, according to a criterion, said subset comprising a number M of pivot points less than the number N of pivot points of said set of pivot points,
at least one step of coding one bit of a binary representation of said scalar integer in a least significant bit of a component of a pivot point comprised into said subset.

According to the present principle, a subset of pivot points is selected from the set of pivot points and used to hide a binary representation of a scalar integer. Such a principle makes it possible to select only some of the pivot points from a set of pivot points representative of a piece-wise linear function to encode the scalar integer. Sensitive pivot points of the piece-wise linear function can then be preserved.

According to a particular embodiment, said encoding method further comprises a step of scaling the scalar integer when the number of bits of the binary representation of the scalar integer is higher than the number M of pivot points comprised in said subset. According to this embodiment, it is possible to adjust the scalar integer value according to the number of pivot points available to encode the scalar integer. Such an embodiment makes it possible to optimize the number of pivot points to be preserved from the data hiding method and the precision of the scalar integer to be encoded by the data hiding method.

According to another aspect of the principle, it is disclosed a method for decoding a scalar integer from at least one parameter representative of a pivot point comprised in a set of pivot points representative of a piece-wise linear function. Said decoding method comprising:
a step of selecting a subset of pivot points from the set of pivot points, according to a criterion, said subset comprising a number M of pivot points less than the number N of pivot points of said set of pivot points,
at least one step of decoding one bit of a binary representation of said scalar integer from a least significant bit of a component of a pivot point comprised into said subset,
a step of reconstructing said scalar integer from decoded bits of said binary representation.

According to another embodiment of said encoding method or said decoding method, the criterion allows to select all the pivot points from the set of pivot points except a first pivot point and a last pivot point from the set of pivot points. According to this embodiment, the most sensitive pivot points of the set of pivot points (first and last pivot points) representative of a piece-wise linear function are not selected and are thus preserved from the data hiding method.

According to another embodiment of said encoding method or said decoding method, the criterion allows selecting the M last pivot points from the set of pivot points.

In the case of HDR image coding, on the decoding side, an adjustment function is used to model a color correction function used to reconstruct the pixel's values of the HDR image from an SDR image. Such an adjustment function can be represented by a piece-wise linear function and is thus transmitted to the decoder by coding a set of pivot points representative of the piece-wise linear function. Such an adjustment function has a flatter shape in the end than in the beginning. Therefore, a reconstruction error at the beginning may have a greater impact on the modeled function than at the end of the shape.

According to this embodiment, the less sensitive pivot points of a piece-wise linear function having a flatter shape in the end than in the beginning can be selected. Therefore, the pivot points that may be more impacted by the data hiding method are preserved.

According to another embodiment, the bits of the binary representation of the scalar integer are hidden in the horizontal component of the pivot points, i.e. the x value of a pivot point. Such an embodiment avoids polluting the vertical component (y value) of the pivot points.

Another aspect of the disclosure is a method for encoding at least one high dynamic range picture into a coded bistream, said method comprising:
a step of decomposing said high dynamic range picture, delivering a standard dynamic range picture and a set of parameters for reconstructing said high dynamic range picture from said standard dynamic range picture decoded from said coded bistream, said set of parameters comprising at least:
   a set of pivot points representative of an adjustment function used to adjust a colour correction function, delivering a modeled colour correction function, said modeled colour correction function being used for modifying the chrominance components of said decoded standard dynamic range picture when reconstructing said high dynamic range picture,
   a scalar integer used to modify the luminance component of said decoded standard dynamic range picture when reconstructing said high dynamic range picture,
a step of encoding said standard dynamic range picture into said coded bistream,
a step of encoding said scalar integer into said coded bistream, wherein encoding said scalar integer comprises:
   selecting a subset of pivot points from the set of pivot points, according to a criterion, said subset comprising a number M of pivot points less than the number N of pivot points of said set of pivot points,
   coding each bit of a binary representation of said scalar integer in a least significant bit of a component of a pivot point belonging to said subset.
a step of encoding said set of pivot points into said coded bistream, by coding each component of each pivot point from the set of pivot points.

Another aspect of the disclosure is a method for decoding at least one high dynamic range picture from a coded bistream, said method comprising:
a step of decoding a standard dynamic range picture from said coded bistream,
a step of decoding a set of N pivot points from said coded bistream, by decoding each component of each pivot point from the set of pivot points, delivering a set of decoded pivot points,
a step of decoding a scalar integer into said coded bistream, wherein decoding said scalar integer comprises:
   selecting a subset of pivot points from the set of decoded pivot points, according to a criterion, said subset comprising a number M of pivot points less than the number N of pivot points of said set of decoded pivot points,
   decoding each bit of a binary representation of said scalar integer from a least significant bit of a component of a decoded pivot point belonging to said subset.
   reconstructing said scalar integer from decoded bits of said binary representation,
a step of determining an adjustment function from said set of decoded pivot points,
a step of determining a modeled colour correction function from a colour correction function adjusted by said adjustment function,
a step of modifying chrominance components of said decoded standard dynamic range picture using said modeled colour correction function,
a step of modifying a luminance component of said decoded standard dynamic range picture using said reconstructed scalar integer,
a step of reconstructing said high dynamic range picture from said modified luminance component and chrominance components of said decoded simple dynamic range picture.

According to one embodiment of the high dynamic range picture encoding method, said method further comprises a step of scaling the scalar integer when the number of bits of the binary representation of the scalar integer is higher than the number M of pivot points comprised in said subset.

According to one embodiment of the high dynamic range picture encoding or decoding method, the criterion allows to select all the pivot points from the set of pivot points except a first pivot point and a last pivot point from the set of pivot points.

According to one embodiment of the high dynamic range picture encoding or decoding method, the criterion allows selecting the M last pivot points from the set of pivot points.

According to one embodiment of the high dynamic range picture encoding or decoding method, the criterion allows selecting the M pivot points from the set of pivot points, preceding the last pivot point from the set of pivot points.

According to one embodiment of the high dynamic range picture encoding or decoding method, said component of a pivot point in which a bit of said binary representation is coded is a horizontal component of the pivot point.

Another aspect of the disclosure is an apparatus for encoding a scalar integer into at least one parameter representative of a pivot point comprised in a set of pivot points representative of a piece-wise linear function, comprising:
means for selecting a subset of pivot points from the set of pivot points, according to a criterion, said subset comprising a number M of pivot points less than the number N of pivot points of said set of pivot points,
means for coding one bit of a binary representation of said scalar integer in a least significant bit of a component of a pivot point comprised into said subset.

Another aspect of the disclosure is an apparatus for decoding a scalar integer from at least one parameter representative of a pivot point comprised in a set of pivot points representative of a piece-wise linear function, comprising:
means for selecting a subset of pivot points from the set of pivot points, according to a criterion, said subset comprising a number M of pivot points less than the number N of pivot points of said set of pivot points,
means for decoding one bit of a binary representation of said scalar integer from a least significant bit of a component of a pivot point comprised into said subset,
means for reconstructing said scalar integer from decoded bits of said binary representation.

Another aspect of the disclosure is an apparatus for encoding at least one high dynamic range picture comprising:
means for decomposing said high dynamic range picture, delivering a standard dynamic range picture and a set of parameters for reconstructing a high dynamic range picture from a decoded standard dynamic range picture, said set of parameters comprising at least:
   a set of pivot points representative of an adjustment function used to adjust a colour correction function, delivering a modeled colour correction function, said modeled colour correction function being used for modifying the chrominance components of said decoded standard dynamic range picture when reconstructing said high dynamic range picture,
   a scalar integer used to modify the luminance component of said decoded standard dynamic range picture when reconstructing said high dynamic range picture,
means for encoding said standard dynamic range picture into said coded bistream,
means for encoding said scalar integer into said coded bistream, wherein means for encoding said scalar integer comprise:
   means for selecting a subset of pivot points from the set of pivot points, according to a criterion, said subset comprising a number M of pivot points less than the number N of pivot points of said set of pivot points,
   means for coding each bit of a binary representation of said scalar integer in a least significant bit of a component of a pivot point belonging to said subset.
means for encoding each component of each pivot point from said set of pivot points into said coded bistream.

Another aspect of the disclosure is an apparatus for decoding at least one high dynamic range picture from a coded bistream, said apparatus comprising:
means for decoding a standard dynamic range picture from said coded bistream,
means for decoding from said coded bistream, each component of each pivot point from a set of pivot points,
means for decoding a scalar integer from said coded bistream, wherein means for decoding said scalar integer comprise:
   means for selecting a subset of pivot points from the set of decoded pivot points, according to a criterion, said subset comprising a number M of pivot points less than the number N of pivot points of said set of decoded pivot points,
   means for decoding each bit of a binary representation of said scalar integer from a least significant bit of a component of a decoded pivot point belonging to said subset,
   means for reconstructing said scalar integer from decoded bits of said binary representation,
means for determining an adjustment function from said set of decoded pivot points,
means for determining a modeled colour correction function from a colour correction function adjusted by said adjustment function,
means for modifying chrominance components of said decoded standard dynamic range picture using said modeled colour correction function,
means for modifying a luminance component of said decoded standard dynamic range picture using said reconstructed scalar integer,
means for reconstructing said high dynamic range picture from said modified luminance component and chrominance components of said decoded simple dynamic range picture.

Another aspect of the disclosure is a computer program comprising software code instructions for performing any one of the embodiments described in the present disclosure, when the computer program is executed by a processor.

Another aspect of the disclosure is a bitstream representative of at least one coded high dynamic range picture comprising:
coded data representative of at least one standard dynamic range picture obtained from said high dynamic range picture,
coded data representative of:
   a set of pivot points representative of an adjustment function used to adjust a colour correction function, delivering a modeled colour correction function, said modeled colour correction function being used for modifying the chrominance components of said standard dynamic range picture when reconstructing said high dynamic range picture,
   a scalar integer used to modify the luminance component of said standard dynamic range picture when reconstructing said high dynamic range picture,
      wherein each bit of a binary representation of said scalar integer is coded in a least significant bit of a component of a pivot point belonging to a subset of pivot points selected from the set of pivot points, according to a criterion, said subset comprising a number M of pivot points less than the number N of pivot points of said set of pivot points.

A non-transitory processor readable medium having stored thereon a bitstream is disclosed wherein the bitstream comprises:
coded data representative of at least one standard dynamic range picture obtained from said high dynamic range picture,
coded data representative of:
   a set of pivot points representative of an adjustment function used to adjust a colour correction function, delivering a modeled colour correction function, said modeled colour correction function being used for modifying the chrominance components of said standard dynamic range picture when reconstructing said high dynamic range picture,
   a scalar integer used to modify the luminance component of said standard dynamic range picture when reconstructing said high dynamic range picture,
      wherein each bit of a binary representation of said scalar integer is coded in a least significant bit of a component of a pivot point belonging to a subset of pivot points selected from the set of pivot points, according to a criterion, said subset comprising a number M of pivot points less than the number N of pivot points of said set of pivot points.

### 4. BRIEF DESCRIPTION OF THE DRAWINGS

FIG. 1 illustrates a block diagram of an exemplary method for encoding a scalar integer, according to an embodiment of the present principle.

FIG. 2 illustrates a block diagram of an exemplary method for decoding a scalar integer, according to an embodiment of the present principle.

FIG. 3 illustrates an exemplary system for encoding an HDR picture into a coded bistream according to an embodiment of the present principle.

FIG. 4 illustrates an exemplary system for decoding an HDR picture into a coded bistream according to an embodiment of the present principle.

FIG. 5 illustrates a block diagram of an exemplary method for decomposing an HDR picture into an SDR picture according to an embodiment of the present principle.

FIG. 6 illustrates a block diagram of an exemplary method for reconstructing an HDR picture from an SDR picture decoded from a coded bistream, according to an embodiment of the present principle.

FIG. 7 shows examples of chromaticity diagrams.

FIG. 8 illustrates a block diagram of an exemplary method for encoding an HDR picture into a coded bistream according to an embodiment of the present principle.

FIG. 9 illustrates a block diagram of an exemplary method for decoding an HDR picture from a coded bistream according to an embodiment of the present principle.

FIG. 10 illustrates an exemplary apparatus for implementing one of the methods disclosed herein according to an embodiment of the present principle.

FIG. 11 illustrates an example of a piece-wise linear function with 6 pivot points.

FIG. 12 illustrates an example of a piece-wise linear function with 6 pivot points modified according to one embodiment of the disclosure.

### 5. DESCRIPTION OF EMBODIMENTS

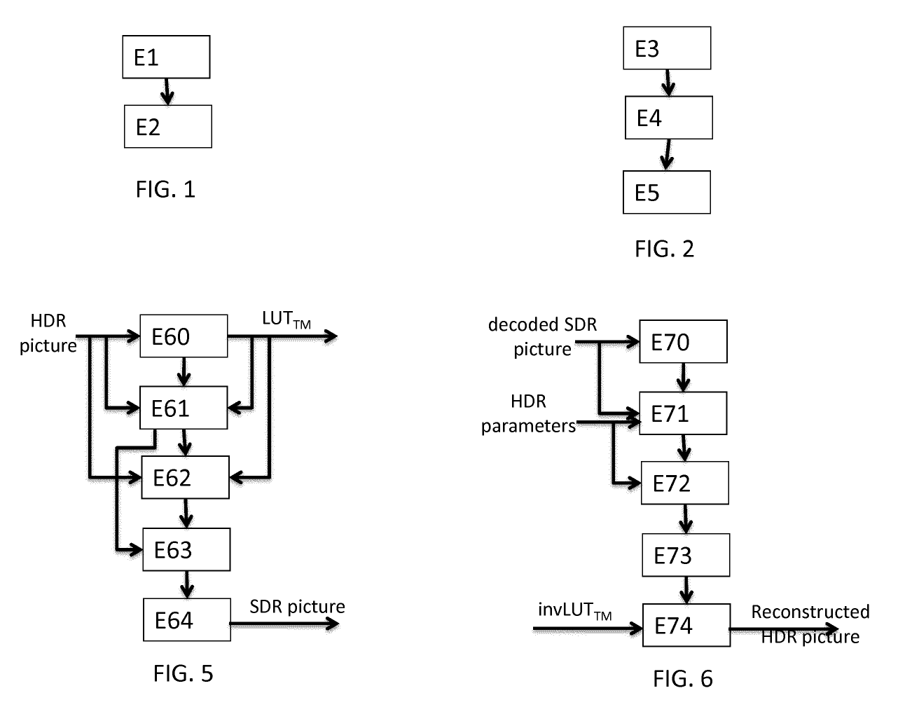

FIG. 1 illustrates a block diagram of an exemplary method for encoding a scalar integer, according to an embodiment of the present principle. According to the disclosed embodiment, a scalar integer v is encoded into at least one parameter representative of a pivot point comprised in a set of pivot points {pv}^{N}, with pv representing a pivot point from the set and N being the number of pivot points from the set. A pivot point comprises at least two components: pvₓ and pv_{y} corresponding respectively to the x and y components of the point along an x-axis and a y-axis.

Such a set {pv}^{N} of pivot points is representative of a piece-wise linear function F. As an example, such piece-wise linear function F may be used for modifying pixel values of a picture which has been decoded from a compressed bitstream. For example, such a piece-wise linear function F may be used for reconstruction of a decoded picture.

According to another example, said encoded scalar integer v may be used to modify pixel values of a picture which has been decoded from a compressed bitstream.

In a step E1, a subset {pv}^{M} of pivot points from the set {pv}^{N} of pivot points is selected according to a criterion. Said subset {pv}^{M} comprises a number M of pivot points such a number M being less than the number N of pivot points of the set {pv}^{N} of pivot points.

According to one embodiment, the criterion allows to select all the pivot points from the set {pv}^{N} of pivot points except a first pivot point and a last pivot point from the set {pv}^{N} of pivot points. In this embodiment, the subset {pv}^{M} comprises the pivot points from the set {pv}^{N} from i=1 to i=N−2. The pivot points of the set {pv}^{N} at i=0 and at i=N−1 are not selected.

According to another embodiment, the criterion allows selecting the M last pivot points from the set {pv}^{N} of pivot points. In this embodiment, the subset {pv}^{M} comprises the pivot points from the set {pv}^{N} from i=N−M to i=N−1. The pivot points of the set {pv}^{N} from i=0 to i=N−M−1 are not selected.

According to another embodiment, the criterion allows selecting the M last pivot points from the set {pv}^{N} of pivot points, except the first pivot point and the last pivot point from the set {pv}^{N} of pivot points. In this embodiment, the subset {pv}^{M} comprises the pivot points from the set {pv}^{N} from i=N−M−1 to i=N−2. The pivot points of the set {pv}^{N} from i=0 to i=N−M−2 and the pivot points at i=N−1 are not selected. In this embodiment, it must be ensured that M is less than or equal to N−2.

A binary representation of the scalar integer v given by b[k], with k=0 to K−1, K being the bit depth used to code v. Here, we assume that M is less than or equal to K.

In a step E2, the bits b[k] of the binary representation of v are coded in a least significant bit (LSB) of a component of the pivot points comprised into the subset {pv}^{M}. Here, we suppose that the subset {pv}^{M} comprises the pivot points from the set {pv}^{N} from i=N−M−1 to i=N−2.

The binary representation of v is obtained as follows:

for each k from 0 to K−1, b[k]=v %2, v/2. Here we assume M is chosen so as to be equal to K.

In step E2, for each k from 0 to K−1, the following applies, where C[k] represents the value of a component of a pivot point pv[k] from the subset {pv}^{M}:

p=b[k], b[k] being the bit k of the binary representation of v,
if p is equal to 1, the LSB of C[N−2−M+1+k] is set to 1, else the LSB of C[k] is set to 0.

According to one embodiment, when the number of bits K of the binary representation of the scalar integer v is higher than the number M of pivot points comprised in the subset {pv}^{M}, the scalar integer v has to be scaled to ensure that the subset comprises a sufficient number of pivot points to encode v.

According to this embodiment, before the coding step E2, v is scaled as: v=v/2^{max(0, K-M)}.

According to one embodiment, the component C[k] of a pivot point into which a bit of the binary representation is coded is a horizontal component pvₓ of the pivot point.

According to an embodiment, the components of the pivot points from the set of pivot points are then coded into a bistream, further stored and transmitted on a transmission medium.

FIG. 2 illustrates a block diagram of an exemplary method for decoding a scalar integer v, according to an embodiment of the present principle. According to the disclosed embodiment, a scalar integer v is decoded from at least one parameter representative of a pivot point comprised in a set of pivot points {pv}^{N}, with pv representing a pivot point from the set and N being the number of pivot points from the set. Such a set {pv}^{N} of pivot points is representative of a piece-wise linear function F. As an example, such piece-wise linear function F may be used for modifying pixel values of a picture which has been decoded from a compressed bitstream. For example, such a piece-wise linear function F may be used for reconstruction of a decoded picture. According to another example, said encoded scalar integer v may be used to modify pixel values of a picture which has been decoded from a compressed bitstream.

According to the disclosed embodiment, the scalar integer v has been coded according to the exemplary embodiment described with FIG. 1. A step E3 of selecting a subset of pivot points from the set of pivot points according to a criterion is performed identically according to the disclosed step E1 described above. Here, we suppose that the subset {pv}^{M} comprises the pivot points from the set {pv}^{N} from i=N−M−1 to i=N−2.

We assume that the bitdepth K of the scalar integer v to be decoded is known from the decoder.

The number of pivot points M used to code the parameter v is derived as: M=min(K, N−2)

In a step E4, the bits b[k] for k=0 to k=M−1 of a binary representation of said scalar integer v are decoded from the least significant bits of a component of the pivot points comprised into said subset. Such a step E4 is performed as follows:

For k=0 to k=M−1, the following applies: b[k]=C[N−2−M+1+k] modulo 2.

In a step E3, the scalar integer v is reconstructed from the decoded bits b[k] as:

v is initialized to 0, and for k=0 to k=M−1v=2*v+b[k].

According to another embodiment, steps E3 and E4 can be performed simultaneously by

v is initialized to 0, and for k=0 to k=M−1v=2*v+(C[N−2−M+1+k] modulo 2).
v has a maximum value of (2^{M}−1).

A last scaling applies. When the final representation of v is in integer format, the scaling can for instance apply as follows v=v×2^{K-M}, leading to an integer of maximum value (2^{K}−1). When the final representation of v is a normalized floating-point format (from 0 to 1), the scaling can for instance apply as follows v=v/(2^{M}−1).

The principle disclosed herein is now described in one particular embodiment. According to the embodiment disclosed below, the scalar integer v and the piece-wise linear function are used in a picture/video distribution system for decomposing high dynamic range picture to standard dynamic range picture and for reconstructing high dynamic range picture from standard dynamic range picture.

In the following, a color picture contains several arrays of samples (pixel values) in a specific picture/video format which specifies all information relative to the pixel values of a picture (or a video) and all information which may be used by a display and/or any other device to visualize and/or decode a picture (or video) for example. A color picture comprises at least one component, in the shape of a first array of samples, usually a luma (or luminance) component, and at least one another component, in the shape of at least one other array of samples. Or, equivalently, the same information may also be represented by a set of arrays of color samples (color components), such as the traditional tri-chromatic RGB representation.

A pixel value is represented by a vector of c values, where c is the number of components. Each value of a vector is represented with a number of bits which defines a maximal dynamic range of the pixel values.

Standard-Dynamic-Range pictures (SDR pictures) are color pictures whose luminance values are represented with a limited dynamic usually measured in power of two or f-stops. SDR pictures have a dynamic around 10 fstops, i.e. a ratio 1000 between the brightest pixels and the darkest pixels in the linear domain, and are coded with a limited number of bits (most often 8 or 10 in HDTV (High Definition Television systems) and UHDTV (Ultra-High Definition Television systems) in a non-linear domain, for instance by using the ITU-R BT.709 OETF (Optico-Electrical-Transfer-Function) (Rec. ITU-R BT.709-5, April 2002) or ITU-R BT.2020 OETF (Rec. ITU-R BT.2020-1, June 2014) to reduce the dynamic. This limited non-linear representation does not allow correct rendering of small signal variations, in particular in dark and bright luminance ranges. In High-Dynamic-Range pictures (HDR pictures), the signal dynamic is much higher (up to 20 f-stops, a ratio one million between the brightest pixels and the darkest pixels) and a new non-linear representation is needed in order to maintain a high accuracy of the signal over its entire range. In HDR pictures, raw data are usually represented in floating-point format (either 32-bit or 16-bit for each component, namely float or half-float), the most popular format being openEXR half-float format (16-bit per RGB component, i.e. 48 bits per pixel) or in integers with a long representation, typically at least 16 bits.

A color gamut is a certain complete set of colors. The most common usage refers to a set of colors which can be accurately represented in a given circumstance, such as within a given color space or by a certain output device.

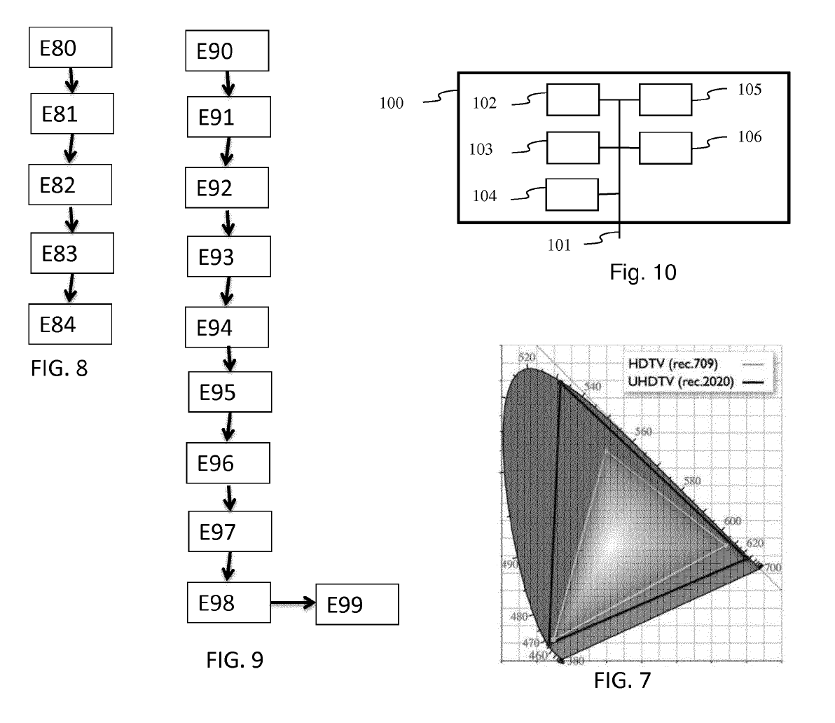

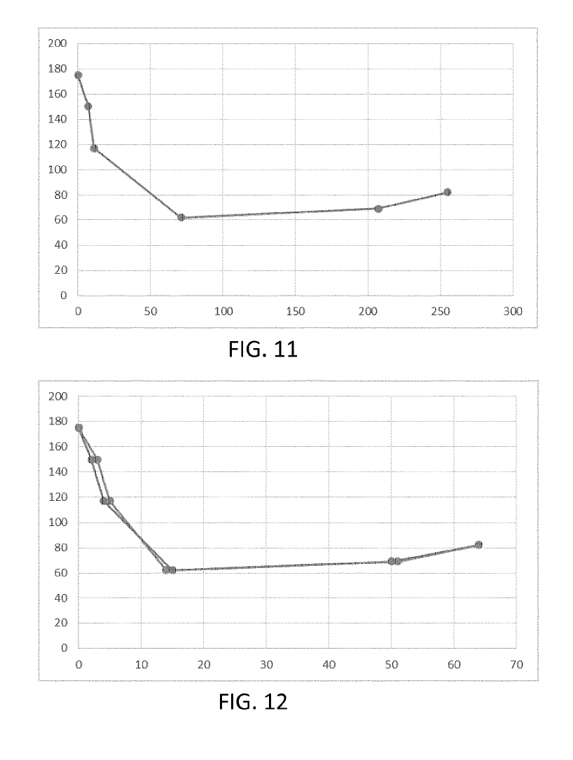

A color gamut is sometimes defined by RGB primaries provided in the CIE1931 color space chromaticity diagram and a white point, as illustrated in FIG. 7.

It is common to define primaries in the so-called CIE1931 color space chromaticity diagram. This is a two dimensional diagram (x,y) defining the colors independently on the luminance component. Any color XYZ is then projected in this diagram thanks to the transform:

$$\{ \begin{matrix}x = \frac{X}{X + Y + Z} \\ y = \frac{Y}{X + Y + Z}\end{matrix}$$

The z=1-x-y component is also defined but carries no extra information.

A gamut is defined in this diagram by a triangle whose vertices are the set of (x,y) coordinates of the three primaries RGB. The white point W is another given (x,y) point belonging to the triangle, usually close to the triangle center. For example, W can be defined as the center of the triangle.

A color volume is defined by a color space and a dynamic range of the values represented in said color space.

For example, a color gamut is defined by a RGB ITU-R Recommendation BT.2020 color space for UHDTV. An older standard, ITU-R Recommendation BT.709, defines a smaller color gamut for HDTV. In SDR, the dynamic range is defined officially up to 100 nits (candela per square meter) for the color volume in which data are coded, although some display technologies may show brighter pixels.

High Dynamic Range pictures (HDR pictures) are color pictures whose luminance values are represented with a HDR dynamic that is higher than the dynamic of a SDR picture.

As explained extensively in “A Review of RGB Color Spaces” by Danny Pascale, a change of gamut, i.e. a transform that maps the three primaries and the white point from a gamut to another, can be performed by using a 3×3 matrix in linear RGB color space. Also, a change of space from XYZ to RGB is performed by a 3×3 matrix. As a consequence, whatever RGB or XYZ are the color spaces, a change of gamut can be performed by a 3×3 matrix. For example, a gamut change from BT.2020 linear RGB to BT.709 XYZ can be performed by a 3×3 matrix.

The HDR dynamic is not yet defined by a standard but one may expect a dynamic range of up to a few thousands nits. For instance, a HDR color volume is defined by a RGB BT.2020 color space and the values represented in said RGB color space belong to a dynamic range from 0 to 4000 nits. Another example of HDR color volume is defined by a RGB BT.2020 color space and the values represented in said RGB color space belong to a dynamic range from 0 to 1000 nits.

Color-grading a picture (or a video) is a process of altering/enhancing the colors of the picture (or the video). Usually, color-grading a picture involves a change of the color volume (color space and/or dynamic range) or a change of the color gamut relative to this picture. Thus, two different color-graded versions of a same picture are versions of this picture whose values are represented in different color volumes (or color gamuts) or versions of the picture whose at least one of their colors has been altered/enhanced according to different color grades. This may involve user interactions.

For example, in cinematographic production, a picture and a video are captured using tri-chromatic cameras into RGB color values composed of 3 components (Red, Green and Blue). The RGB color values depend on the tri-chromatic characteristics (color primaries) of the sensor. A first color-graded version of the captured picture is then obtained in order to get theatrical renders (using a specific theatrical grade). Typically, the values of the first color-graded version of the captured picture are represented according to a standardized YUV format such as BT.2020 which defines parameter values for UHDTV.

The YUV format is typically performed by applying a non-linear function, so called Optical Electronic Transfer Function (OETF) on the linear RGB components to obtain non-linear components R′G′B′, and then applying a color transform (usually a 3×3 matrix) on the obtained non-linear R′G′B′ components to obtain the three components YUV. The first component Y is a luminance component and the two components U,V are chrominance components.

Then, a Colorist, usually in conjunction with a Director of Photography, performs a control on the color values of the first color-graded version of the captured picture by fine-tuning/tweaking some color values in order to instill an artistic intent.

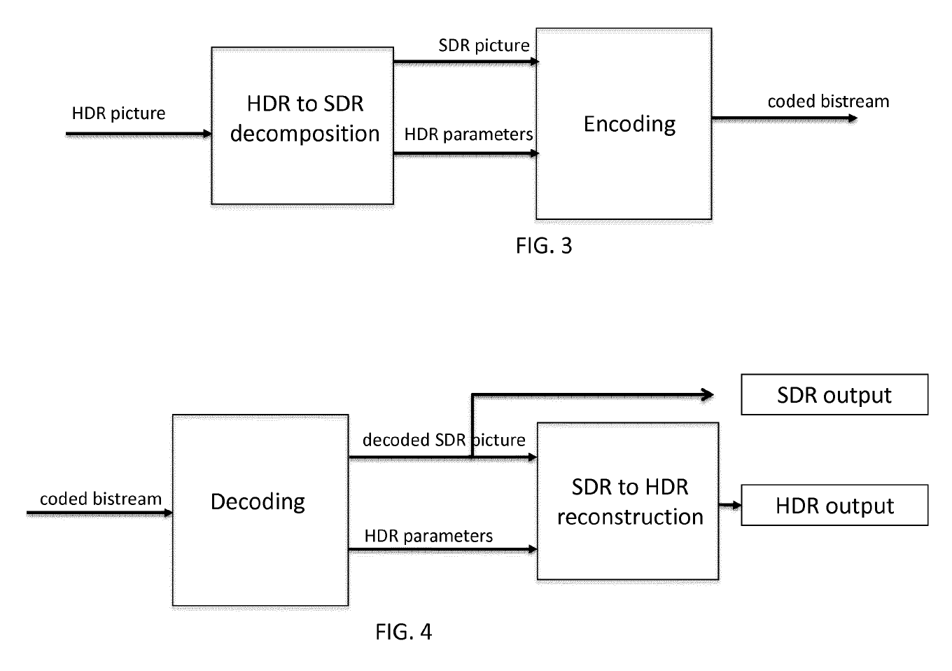

FIG. 3 illustrates an exemplary system for encoding an HDR picture into a coded bistream according to an embodiment of the present principle. Such an encoding system may be used for distributing a compressed HDR video while at the same time distributing an associated SDR video representative of the HDR video with a more limited dynamic range. Such an encoding system provides a solution for SDR backward compatible HDR distribution.

The disclosure is described for encoding/decoding a color HDR picture but extends to the encoding/decoding of a sequence of pictures (video) because each color picture of the sequence is sequentially encoded/decoded as described below.

An HDR picture is first inputted to a module of HDR to SDR decomposition. Such a module performs HDR to SDR decomposition and outputs an SDR picture which is a dynamic reduced version of the input HDR picture. Such an SDR picture is a reshaped version of the input HDR picture such that the hue and perceived saturation are preserved and the visual quality of the SDR picture relative to the HDR picture is increased. The HDR to SDR decomposition module also outputs a set of HDR parameters which are further used for HDR picture reconstruction.

The SDR picture is then input to an encoding module performing picture encoding. Such an encoding module may be for example an HEVC Main 10 coder suitable for encoding video and picture represented on a 10 bit-depth. The encoding module outputs a coded bitstream representative of a compressed version of SDR picture. The HDR parameters are also encoded by the encoding module as part of the coded bistream. As an example, such HDR parameters may be coded in SEI message (Supplemental Enhancement Information message) of an HEVC Main 10 bistream.

Such a coded bistream may then be stored or transmitted over a transmission medium.

FIG. 4 illustrates an exemplary system for decoding an HDR picture from a coded bistream according to an embodiment of the present principle. As an example, the coded bistream is conformed to the HEVC Main 10 profile.

Such a coded bistream comprises coded data representative of an SDR picture and coded data representative of HDR parameters suitable for reconstructing an HDR picture from a decoded version of the SDR picture compressed in the coded bistream.

Such a coded bistream may be stored in a memory or received from a transmission medium. The coded bistream is first input to a decoding module performing picture decoding and HDR parameters decoding. The decoding module may be for example a decoder conformed to an HEVC Main 10 profile decoder.

The decoding module outputs a decoded SDR picture and a set of HDR parameters. The decoded SDR picture may be displayed by a legacy SDR display (SDR output). Such an SDR picture may be viewable by an end-user from his legacy SDR display. Thus, the disclosed system is backward compatible with any SDR legacy display.

The decoded SDR picture and HDR parameters are then input to a module for SDR to HDR reconstruction. Such a module reconstructs the HDR picture from the decoded SDR picture using the given HDR parameters. Then, a decoded HDR picture is output and can be displayed by an HDR compatible display (HDR output).

FIG. 5 illustrates a block diagram of an exemplary method for decomposing an HDR picture into an SDR picture according to an embodiment of the present principle. Such a method may be performed by the HDR to SDR decomposition module disclosed in FIG. 5A.

The HDR-to-SDR decomposition process aims at converting an input linear-light 4:4:4 HDR picture, to an SDR compatible version (also in 4:4:4 format). Such a process uses side information such as the mastering display peak luminance, colour primaries, and the colour gamut of the container of the HDR and SDR pictures. Such side information are determined from the characteristics of the picture or of the video. The HDR-to-SDR decomposition process generates an SDR backward compatible version from the input HDR signal, using an invertible process that guarantees a high quality reconstructed HDR signal.

In a step E60, from the input HDR picture and its characteristics (side information), mapping variables are derived. Such a step E60 of mapping parameters derivation delivers a luminance mapping function LUT_{TM}.

In a step E61, the luminance signal of the HDR picture is mapped to an SDR luma signal using the luminance mapping variables. That is for each pixel of the input HDR picture, the luminance L is derived from the HDR linear-light RGB values of the pixel and from the luminance mapping function as:

$$L = {A}_{1} [ \begin{matrix}R \\ G \\ B\end{matrix} ] ,$$

with A=[A₁ A₂ A₃]^{T} being the conventional 3×3 R′G′B′-to-Y′CbCr conversion matrix (e.g. BT.2020 or BT.709 depending on the colour space), A₁, A₂, A₃ being 1×3 matrices.

The linear-light luminance L is mapped to an SDR-like luma Y_{pre,0}, using the luminance mapping function: Yₚᵣₑ₀=LUT_{TM}(L).

In a step E62, a mapping of the colour to derive the chroma (chrominance) components of the SDR signal is applied. The chroma components Uₚᵣₑ₀, Vₚᵣₑ₀ are built as follows:

A pseudo-gammatization using square-root (close to BT.709 OETF) is applied to the RGB values of the pixel as

$$[ \begin{matrix}{R}_{S} \\ {G}_{S} \\ {B}_{S}\end{matrix} ] = [ \begin{matrix}\sqrt{R} \\ \sqrt{G} \\ \sqrt{B}\end{matrix} ]$$

Then the Uₚᵣₑ₀ and Vₚᵣₑ₀ values are derived as follows:

$$[ \begin{matrix}{U}_{pre 0} \\ {V}_{pre 0}\end{matrix} ] = [ \begin{matrix}{A}_{2} \\ {A}_{3}\end{matrix} ] [ \begin{matrix}{R}_{S} \\ {G}_{S} \\ {B}_{S}\end{matrix} ] \times 1024$$

This step E62 results in a gamut shifting. Such a gamut shifting is corrected by a step E63 of color gamut correction. In step E63, the chroma component values are corrected as follows:

$$[ \begin{matrix}{U}_{pre 1} \\ {V}_{pre 1}\end{matrix} ] = \frac{1}{{β}_{0} ( {Y}_{pre 0} )} \cdot [ \begin{matrix}{U}_{pre 0} \\ {V}_{pre 0}\end{matrix} ] = \frac{1024}{{β}_{0} ( {Y}_{pre 0} )} \cdot [ \begin{matrix}{A}_{2} \\ {A}_{3}\end{matrix} ] [ \begin{matrix}\sqrt{R} \\ \sqrt{G} \\ \sqrt{B}\end{matrix} ] ,$$

where A₂, A₃ are made of the second and third lines of coefficients of the conversion matrix from R′G′B′-to-Y′CbCr, and β₀ is a pre-processing colour correction LUT (for Look Up Table).

The luma component is corrected as follows:

Yₚᵣₑ₁=Yₚᵣₑ₀−ν×max(0, a×Uₚᵣₑ₁+b×Vₚᵣₑ₁), where a and b are pre-defined parameters, and ν is a parameter that enables to control the level of chroma re-injection into the luma component. This parameter enables to actually control the perceived saturation of the colors (in general a lower luma value, for same chroma components, generates a higher perceived saturation).

The HDR picture to SDR picture decomposition results in an output SDR picture comprising arrays ol pixels Yₚᵣₑ₁Uₚᵣₑ₁Vₚᵣₑ₁.

FIG. 6 illustrates a block diagram of an exemplary method for reconstructing an HDR picture from an SDR picture decoded from a coded bistream, according to an embodiment of the present principle. Such a method may be performed by the SDR to HDR reconstruction module disclosed in FIG. 5B.

The HDR reconstruction process is the inverse of the HDR-to-SDR decomposition process. A decoded SDR picture comprises 3 arrays of pixels SDR_{y}, SDR_{cb}, SDR_{cr} corresponding respectively to the luma and chroma components of the picture. The HDR reconstruction process the following steps for each pixel of the SDR picture.

In a step E70, the values Uₚₒₛₜ₁ and Vₚₒₛₜ₁ are derived as follows for each pixel (x,y) of the SDR picture:

$$\{ \begin{matrix}{U}_{post 1} = {SDR}_{cb} [ x ] [ y ] - midSampleVal \\ {V}_{post 1} = {SDR}_{cr} [ x ] [ y ] - midSampleVal\end{matrix}$$

where midSampleVal is a predefined shifting constant.

In a step E71, the value Yₚₒₛₜ₁ for the pixel (x,y) of the SDR picture is derived as follows:

Yₚₒₛₜ₁=SDR_{y}[x][y]+ν×max(0,a×Uₚₒₛₜ₁+b×Vₚₒₛₜ₁),

where ν, a and b are the same pre-defined parameters as in the decomposition process.

Therefore, such parameters should be known to the reconstruction module. ν is the same parameter as above, used to control the level of chroma re-injection into the luma component, and therefore to control the perceived saturation.

Such a step may possibly be followed by a clipping to avoid to be out of the legacy signal range. In a step E72, colour correction is performed. In step E72, Uₚₒₛₜ₁ and Vₚₒₛₜ₁ are modified as follows:

$$\{ \begin{matrix}{U}_{post 1} = {β}_{p} [ {Y}_{post 1} ] \times {U}_{post 1} \\ {V}_{post 1} = {β}_{p} [ {Y}_{post 1} ] \times {V}_{post 1}\end{matrix}$$

where βₚ is a post-processing colour correction LUT, that depends directly on the pre-processing colour correction LUT β₀.

The post-processing colour correction LUT βₚ can be determined by:

$${β}_{P} ( Y ) = \frac{{β}_{O} ( Y )}{K \times \sqrt{L ( Y )}} \qquad ( eq . 1 )$$

where K is a constant value, L is the linear-light luminance derived from L=invLUT_{TM}[Y], with invLUT_{TM} being the inverse function of the LUT_{TM}, and Y the luma value of the SDR signal.

In step E73, RGB (HDR_{R}, HDR_{G}, HDR_{B}) values of pixels are reconstructed. In step E73, a value T is derived as:

T=k0×Uₚₒₛₜ₁×Vₚₒₛₜ₁+k1×Uₚₒₛₜ₁×Uₚₒₛₜ₁+k2×Vₚₒₛₜ₁×Vₚₒₛₜ₁

where k0, k1, k2 are predefined values depending on the SDR colour gamut. The value S0 is then initialized to 0, and the following applies:
If (T≤1), S0 is set to Sqrt(1−T)
Else, Uₚₒₛₜ₁ and Vₚₒₛₜ₁ are modified as follows:

$$\{ \begin{matrix}{U}_{post 1} = \frac{{U}_{post 1}}{\sqrt{T}} \\ {V}_{post 1} = \frac{{V}_{post 1}}{\sqrt{T}}\end{matrix}$$

The values R1, G1, B1 are derived as follows.

$$[ \begin{matrix}R 1 \\ G 1 \\ B 1\end{matrix} ] = {M}_{{Y}^{′} CbCr \text{-} to \text{-} {R}^{′} {G}^{′} {B}^{′}} \times [ \begin{matrix}S 0 \\ {U}_{post 1} \\ {V}_{post 1}\end{matrix} ]$$

where M_{Y′CbCr-to-R′G′B′} is the conventional conversion matrix from Y′CbCr to R′G′B′.

In a step E74, the RGB values from the HDR picture are then reconstructed from the SDR RGB values. In step E74, the values R2, G2, B2 are derived from R1, G1, B1 as follows:

$$\{ \begin{matrix}R 2 = lutMapY [ {Y}_{post 1} ] \times R 1 \\ G 2 = lutMapY [ {Y}_{post 1} ] \times G 1 \\ B 2 = lutMapY [ {Y}_{post 1} ] \times B 1\end{matrix}$$

where lutMapY corresponds to the invLUT_{TM} look-up-table derived from the luma mapping parameters transmitted to the reconstruction module.

And the output samples HDR_{R}, HDR_{G}, HDR_{B} are derived from R2, G2, B2 as follows:

$$\{ \begin{matrix}{HDR}_{R} = R {2}^{2} \\ {HDR}_{G} = G {2}^{2} \\ {HDR}_{B} = B {2}^{2}\end{matrix}$$

A clipping may be applied to limit the range of the output HDR signal.

It can be seen from the reconstruction process disclosed above that some parameters used during the decomposition stage on the encoder side and depending on the content of the original HDR picture should be known on the decoder side. As an example, the post-processing colour correction LUT βₚ is determined by equation eq. 1 depending directly on the pre-processing colour correction LUT β₀ used at in the decomposition process.

In order to ensure a high fidelity of the SDR signal to the HDR signal, the computation of the pre-processing colour correction β₀ is performed at the encoding side by a minimisation of a reconstruction error between the RGB SDR signal and the RGB HDR signal. Such a minimisation operation is controlled by saturation parameter (saturation skew) of the picture and enables to control the color saturation of the derived SDR signal. Therefore, the pre-processing colour correction function β₀, and thus the post-processing colour correction function βₚ, are dependent from the original HDR picture. The same derivation process of the post-processing colour correction function βₚ can not be applied at the decoder side.

Therefore, a solution has been proposed for deriving the post-processing colour correction function βₚ at the decoder side. A set of pre-defined default LUTs β_{P}_{_}_{default}[k], k=1 to Nb, is predefined on the decoder side. For instance, one LUT is defined for each triple (container colour gamut, content colour gamut, peak luminance). At the pre-processing side, an adjustment function f_{adj} is built to map as much as possible the LUT β_{P}_{_}_{default}[k] to the real LUT βₚ, that is such that

β_{P}_{_}_{cod}[Y]=f_{adj}[Y]×β_{P}_{_}_{default}[k][Y] (eq.2)

is as close as possible to β_{P}_{_}ᵣₑₐₗ[Y] for all Y values, where β_{P}_{_}ᵣₑₐₗ is derived from the pre-processing colour correction function β₀ using equation eq.1, i.e. βₚ. In the present embodiment, f_{adj} is built by minimization of an error based on equation eq.2 relationship between β_{P}_{_}_{default}[k] et βₚ, however any types of relationship may be used.

Then, the f_{adj} function is coded and transmitted to the decoder side.

To limit the coding cost of f_{adj}, the function f_{adj} is modeled using pivot points of a piece-wise linear model. Only the set of pivot points representative of the f_{adj} function are coded.

At the post-processing step, the set of pivot points is decoded, the function f_{adj} is built and the β_{P}_{_}_{cod} LUT is reconstructed from the default LUT β_{P}_{_}_{default}, which is identified thanks to the coded content characteristics parameters, and f_{adj} by applying equation eq.2.

It can be seen from the reconstruction process disclosed with FIG. 6, that the ν, a and b parameters should also be known on the decoder side. a, b could be predefined parameters at the decoder. Therefore, a and b don't need to be transmitted.

The parameter ν is a parameter that enables to control the level of chroma re-injection into the luma component. This parameter enables to actually control the perceived saturation of the colors (in general a lower luma value, for same chroma components, generates a higher perceived saturation)

Therefore, such a parameter should be transmitted to the decoder.

FIG. 8 illustrates a block diagram of an exemplary method for encoding an HDR picture into a coded bistream according to an embodiment of the present principle. Such an encoding method uses the principle disclosed in FIG. 1 for coding the parameter ν.

In a step E80, the decomposition process described in relation with FIG. 5 decomposes an HDR picture to code. Such a decomposition process delivers a standard dynamic range picture and a set of parameters for reconstructing the HDR picture from a decoded version of the SDR output picture. Said set of parameters comprises at least:
a set {pv}^{N} of pivot points representative of the adjustment function f_{adj}, where N is the number of pivot points necessary for representing the adjustment function f_{adj},
a scalar integer ν used to modify the luminance component of said decoded SDR picture at the reconstruction stage.

In a step E81, the output SDR picture is encoded into a coded bistream as described for example with FIG. 3.

The scalar integer ν is encoded into said coded bistream using the principle disclosed in relation with FIG. 1. In step E82, a subset of pivot points from the set {pv}^{N} of pivot points is selected as described in step E1 explained in reference to FIG. 1. Said selected subset comprises a number M of pivot points less than N.

In step E83, the bits of the binary representation of the parameter ν is encoded in the LSB of a component of the pivot points belonging to the subset. Such step E83 is performed according to step E2 of FIG. 1.

According to one embodiment, the number of pivot points representative of the adjustment function is N=6, the number M of bits necessary to code the parameter ν is 4, the bitdepth of the pivot points component is 8 bits and the bits of the binary representation of the parameter ν are coded in the x values of the pivot points.

In step E84, said set {pv}^{N} of pivot points is encoded into said coded bistream. Said set {pv}^{N} of pivot points comprises unmodified pivot points, i.e. the pivot points which have not been selected in step E82, and modified pivot points, i.e. the pivot points which have been selected in step E82 and modified in step E83. A piece-wise linear function with modified pivot points is illustrated in FIG. 12.

Each pivot point of the set {pv}^{N} is coded by coding of each component. The pivot points from the set {pv}^{N} are coded into the coded bistream as HDR parameters or supplemental information as disclosed in relation with FIG. 3.

FIG. 9 illustrates a block diagram of an exemplary method for decoding an HDR picture from a coded bistream according to an embodiment of the present principle. Such an decoding method uses the principle disclosed in FIG. 2 for decoding the parameter ν.

In a step E90, a standard dynamic picture is decoded from a coded bistream as described in FIG. 4.

In step E91, a set of N pivot points {pv}^{N} is decoded from said coded bistream. In step E91, each component of each pivot point from the set of pivot points is decoded. The pivot points from the set {pv}^{N} are decoded from the coded bistream as HDR parameters or supplemental information as disclosed in relation with FIG. 4. Step E91 delivers a set of decoded pivot points.

Then the parameter ν is decoded from the set of decoded pivot points. For this, in a step E92, a subset of pivot points from the set of decoded pivot points is selected as described in step E3 from FIG. 2. Said subset comprising a number M of pivot points less than the number N of pivot points of said set of decoded pivot points.

In a step E93, each bit of the binary representation of the parameter ν is decoded from the least significant bit of a component of the decoded pivot points belonging to said subset, as disclosed in step E4 from FIG. 2.

In a step E94, the parameter ν is reconstructed from the decoded bits of said binary representation, as disclosed in step E5 from FIG. 2.

In a step E95, the adjustment function f_{adj}, is determined from the set of decoded pivot points.

Such function f_{adj} is determined as a piece-wise linear function represented by the decoded pivot points.

In a step E96, the post-processing colour correction function β_{P}_{_}_{cod} is determined from a colour correction function β_{P}_{_}_{default}[k] and said adjustment function f_{adj}.

As an example, the post-processing colour correction function β_{P}_{_}_{cod} is determined by β_{P}_{_}_{cod}[Y]=f_{adj}[Y]×β_{P}_{_}_{default}[k][Y] fro each Y values of luminance.

The colour correction function β_{P}_{_}_{default}[k] is part of a set of K colour correction function β_{P}_{_}_{default} that are known to the decoder. As example, such set of K colour correction function β_{P}_{_}_{default} can be stored in a memory of the decoder or transmitted to the decoder as part of a video sequence parameters.

The colour correction function β_{P}_{_}_{default}[k] used for adjusting the post-processing colour correction function β_{P}_{_}_{cod} may be selected according to the gamut of the SDR picture compressed in the bistream. The gamut of the SDR picture may be transmitted to the decoder as side information, for example as video or picture level parameters. According to another example, the index k can be transmitted to the decoder as part of the HDR parameters coded for the picture.

In a step E97, the luminance component of the decoded SDR picture is modified using the reconstructed parameter ν. In step E97, the pixels of the decoded SDR picture are scanned and the chroma components are modified as described in step E70 explained with FIG. 6. Then, the luma component of SDR picture is modified as in step E71 of FIG. 6 using the reconstructed parameter ν.

In a step E98, the chroma components of the decoded SDR picture are modified using the adjusted post-processing colour correction function _{P}_{_}_{cod} determined in step E96. Step E98 is performed as step E72 from FIG. 6.

In a step E99, the HDR picture is reconstructed from the luminance and chroma components modified in step E97 et E98. Step E99 is performed as steps E73 and E74 from FIG. 6.

On FIGS. 1 to 9, the method steps are performed by modules, which are functional units, such modules may or not be in relation with distinguishable physical units. For example, these modules or some of them may be brought together in a unique component or circuit, or contribute to functionalities of a software. A contrario, some modules may potentially be composed of separate physical entities. The apparatus which are compatible with the disclosure are implemented using either pure hardware, for example using dedicated hardware such ASIC or FPGA or VLSI, respectively «Application Specific Integrated Circuit», «Field-Programmable Gate Array», «Very Large Scale Integration», or from several integrated electronic components embedded in a device or from a blend of hardware and software components.

FIG. 10 represents an exemplary architecture of a device 100 which may be configured to implement a method described in relation with FIGS. 1-9.

Device 100 comprises following elements that are linked together by a data and address bus 101:
a microprocessor 102 (or CPU), which is, for example, a DSP (or Digital Signal Processor);
a ROM (or Read Only Memory) 103;
a RAM (or Random Access Memory) 104;
an I/O interface 105 for transmission and/or reception of data, from an application; and
a battery 106.

According to a variant, the battery 106 is external to the device. Each of these elements of FIG. 10 are well-known by those skilled in the art and won't be disclosed further. In each of mentioned memory, the word «register» used in the specification can correspond to area of small capacity (some bits) or to very large area (e.g. a whole program or large amount of received or decoded data). ROM 103 comprises at least a program and parameters. Algorithm of the methods according to the disclosure is stored in the ROM 103. When switched on, the CPU 102 uploads the program in the RAM and executes the corresponding instructions.

RAM 104 comprises, in a register, the program executed by the CPU 102 and uploaded after switch on of the device 100, input data in a register, intermediate data in different states of the method in a register, and other variables used for the execution of the method in a register.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

According to a specific embodiment of encoding or encoder, the HDR color picture is obtained from a source. For example, the source belongs to a set comprising:
a local memory (103 or 104), e.g. a video memory or a RAM (or Random Access Memory), a flash memory, a ROM (or Read Only Memory), a hard disk;
a storage interface, e.g. an interface with a mass storage, a RAM, a flash memory, a ROM, an optical disc or a magnetic support;
a communication interface (105), e.g. a wireline interface (for example a bus interface, a wide area network interface, a local area network interface) or a wireless interface (such as a IEEE 802.11 interface or a Bluetooth® interface); and
a picture capturing circuit (e.g. a sensor such as, for example, a CCD (or Charge-Coupled Device) or CMOS (or Complementary Metal-Oxide-Semiconductor)).

According to different embodiments of the decoding or decoder, the HDR decoded picture is sent to a destination; specifically, the destination belongs to a set comprising:
a local memory (103 or 104), e.g. a video memory or a RAM (or Random Access Memory), a flash memory, a ROM (or Read Only Memory), a hard disk;
a storage interface, e.g. an interface with a mass storage, a RAM, a flash memory, a ROM, an optical disc or a magnetic support;
a communication interface (105), e.g. a wireline interface (for example a bus interface, a wide area network interface, a local area network interface) or a wireless interface (such as a IEEE 802.11 interface or a Bluetooth® interface); and
a display.

According to different embodiments of encoding or encoder, the coded bitstream is sent to a destination. As an example, the coded bistream is stored in a local or remote memory, e.g. a video memory (104) or a RAM (104), a hard disk (103). In a variant, the bistream is sent to a storage interface, e.g. an interface with a mass storage, a flash memory, ROM, an optical disc or a magnetic support and/or transmitted over a communication interface (105), e.g. an interface to a point to point link, a communication bus, a point to multipoint link or a broadcast network.

According to different embodiments of decoding or decoder, the bitstream is obtained from a source. Exemplarily, the bitstream is read from a local memory, e.g. a video memory (104), a RAM (104), a ROM (103), a flash memory (103) or a hard disk (103). In a variant, the bitstream is received from a storage interface, e.g. an interface with a mass storage, a RAM, a ROM, a flash memory, an optical disc or a magnetic support and/or received from a communication interface (105), e.g. an interface to a point to point link, a bus, a point to multipoint link or a broadcast network.

According to different embodiments, device 100 being configured to implement an encoding method described in relation with FIG. 1, 3 or 8, belongs to a set comprising:
a mobile device;
a communication device;
a game device;
a tablet (or tablet computer);
a laptop;
a still picture camera;
a video camera;
an encoding chip;
a still picture server; and
a video server (e.g. a broadcast server, a video-on-demand server or a web server).

According to different embodiments, device 100 being configured to implement a decoding method described in relation with FIG. 2, 4 or 9, belongs to a set comprising:
a mobile device;
a communication device;
a game device;
a set top box;
a TV set;
a tablet (or tablet computer);
a laptop;
a display and
a decoding chip.

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and any other device for processing a picture or a video or other communication devices. As should be clear, the equipment may be mobile and even installed in a mobile vehicle.

Additionally, the methods may be implemented by instructions being performed by a processor, and such instructions (and/or data values produced by an implementation) may be stored on a computer readable storage medium. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1-20. (canceled)

21. A method comprising:
selecting, according to a criterion, at least one pivot point representative of a piece-wise linear function comprising at least one linear segment, said at least one pivot point defining the beginning or the end of a linear segment and comprising at least two components defining a spatial location of said pivot point;
encoding at least one one bit of a binary representation of a scalar value to be encoded in a least significant bit of a component of at least one selected pivot point, said scalar value being intended to be used when modifying pixel values of a picture; and
encoding said at least one selected pivot point, by encoding the components of said at least one selected pivot point.

22. The method of claim 21, wherein said method further comprises scaling the scalar value when the number of bits of the binary representation of the scalar value is higher than the number of selected pivot points.

23. A method comprising:
decoding at least one pivot point by decoding the components of said at least one pivot point, said at least one decoded pivot point being representative of a piece-wise linear function comprising at least one linear segment, said at least one decoded pivot point defining the beginning or the end of a linear segment and comprising at least two components defining a spatial location of said decoded pivot point;
selecting at least one pivot point according to a criterion from said at least one decoded pivot point;
decoding at least one bit of a binary representation of a scalar value to be decoded from a least significant bit of a component of at least one selected pivot point; and
reconstructing said scalar value from said at least one decoded bit of said binary representation.

24. The method of claim 21, wherein said piece-wise linear function comprising at least two linear segments, and wherein the criterion allows to select all the pivot points representative of said piece-wise linear function except a first pivot point and a last pivot point from the set of pivot points.

25. The method of claim 23, wherein said piece-wise linear function comprising at least two linear segments, and wherein the criterion allows to select all the pivot points representative of said piece-wise linear function except a first pivot point and a last pivot point from the set of pivot points.

26. The method of claim 21, wherein the criterion allows selecting the M last pivot points, wherein M is an integer value.

27. The method of claim 23, wherein the criterion allows selecting the M last pivot points, wherein M is an integer value.

28. The method of claim 21, wherein the criterion allows selecting the M pivot points from the set of pivot points preceeding the last pivot point, wherein M is an integer value.

29. The method of claim 23, wherein the criterion allows selecting the M pivot points from the set of pivot points preceeding the last pivot point, wherein M is an integer value.

30. The method of claim 21, wherein said component of a selected pivot point is the abscisse of the spatial location of said selected pivot point.

31. The method of claim 23, wherein said component of a selected pivot point is the abscisse of the spatial location of said selected pivot point.

32. A method for encoding at least one high dynamic range picture into a coded bistream, said method comprising:
decomposing said high dynamic range picture, delivering and encoding, in said coded bitstream, a standard dynamic range picture and a set of parameters for reconstructing a high dynamic range picture from a decoded standard dynamic range picture and a decoded set of parameters, said set of parameters comprising:
at least pivot point defining the beginning or the end of a linear segment of an adjustment function comprising at least one linear segment, a pivot point comprising at least two components defining a spatial location of said pivot point, said adjustment function being used to adjust a colour correction function, said adjusted colour correction function being used for modifying the chrominance components of said decoded standard dynamic range picture when reconstructing said high dynamic range picture;
a scalar value used to modify the luminance component of said decoded standard dynamic range picture when reconstructing said high dynamic range picture;
encoding said scalar value into said coded bistream by:
selecting at least one pivot point according to a criterion;
encoding at least one bit of a binary representation of said scalar value in a least significant bit of a component of at least one selected pivot point.

33. A method for decoding at least one high dynamic range picture from a coded bistream, said method comprising:
decoding a standard dynamic range picture from said coded bistream,
decoding at least one pivot point by decoding the components of said at least one pivot point, said at least one decoded pivot point being representative of an adjustment function comprising at least one linear segment, said at least one decoded pivot point defining the beginning or the end of a linear segment and comprising at least two components defining a spatial location of said decoded pivot point,
reconstructing a scalar integer by:
selecting at least one pivot point according to a criterion from said at least one decoded pivot point;
decoding at least one bit of a binary representation of said scalar value from a least significant bit of a component of at least one selected pivot point;
reconstructing said scalar value from said at least one decoded bit of said binary representation;
determining a corrected colour correction function from a colour correction function adjusted by said adjustment function;
modifying a luminance component of said decoded standard dynamic range picture using said reconstructed scalar value;
modifying chrominance components of said decoded standard dynamic range picture using said corrected colour correction function; and
reconstructing said high dynamic range picture from said modified luminance component and chrominance components of said decoded standard dynamic range picture.

34. The method of claim 32, wherein said method further comprises scaling the scalar value when the number of bits of the binary representation of the scalar integer is higher than the number of selected pivot points.

35. The method of claim 33, wherein said method further comprises scaling the scalar value when the number of bits of the binary representation of the scalar integer is higher than the number of selected pivot points.

36. The method of claim 32, wherein said adjustment function comprising at least two linear segments, and wherein the criterion allows to select all the pivot points representative of said adjustment function except a first pivot point and a last pivot point.

37. The method of claim 33, wherein said adjustment function comprising at least two linear segments, and wherein the criterion allows to select all the pivot points representative of said adjustment function except a first pivot point and a last pivot point.

38. The method of claim 32, wherein the criterion allows selecting the M last pivot points, wherein M is an integer value.

39. The method of claim 33, wherein the criterion allows selecting the M last pivot points, wherein M is an integer value.

40. The method of claim 32, wherein said component of a selected pivot point is the abscisse of the spatial location of said selected pivot point.

41. The method of claim 33, wherein said component of a selected pivot point is the abscisse of the spatial location of said selected pivot point.

42. The method of claim 32, wherein the number of pivot points representative of the adjustment function is equal to 6 and the number of selected pivot points is equal to 4.

43. The method of claim 33, wherein the number of pivot points representative of the adjustment function is equal to 6 and the number of selected pivot points is equal to 4.

44. An apparatus, comprising a processor configured to:
select, according to a criterion, at least one pivot point representative of a piece-wise linear function comprising at least one linear segment, said at least one pivot point defining the beginning or the end of a linear segment and comprising at least two components defining a spatial location of said pivot point;
encode at least one one bit of a binary representation of a scalar value to be encoded in a least significant bit of a component of at least one selected pivot point, said scalar value being intended to be used when modifying pixel values of a picture; and
encode said at least one selected pivot point, by encoding the components of said at least one selected pivot point.

45. An apparatus, comprising a processor configured to:
decode at least one pivot point by decoding the components of said at least one pivot point, said at least one decoded pivot point being representative of a piece-wise linear function comprising at least one linear segment, said at least one decoded pivot point defining the beginning or the end of a linear segment and comprising at least two components defining a spatial location of said decoded pivot point;
select at least one pivot point according to a criterion from said at least one decoded pivot point;
decode at least one bit of a binary representation of a scalar value to be decoded from a least significant bit of a component of at least one selected pivot point; and
reconstruct said scalar value from said at least one decoded bit of said binary representation.

46. An apparatus for encoding at least one high dynamic range picture into a coded bistream, said apparatus comprising a processor configured to:
decompose said high dynamic range picture, delivering and encoding, in said coded bitstream, a standard dynamic range picture and a set of parameters for reconstructing a high dynamic range picture from a decoded standard dynamic range picture and a decoded set of parameters, said set of parameters comprising:
at least pivot point defining the beginning or the end of a linear segment of an adjustment function comprising at least one linear segment, a pivot point comprising at least two components defining a spatial location of said pivot point, said adjustment function being used to adjust a colour correction function, said adjusted colour correction function being used for modifying the chrominance components of said decoded standard dynamic range picture when reconstructing said high dynamic range picture;
a scalar value used to modify the luminance component of said decoded standard dynamic range picture when reconstructing said high dynamic range picture;
encode said scalar value into said coded bistream by:
selecting at least one pivot point according to a criterion;
encoding at least one bit of a binary representation of said scalar value in a least significant bit of a component of at least one selected pivot point.

47. An apparatus for decoding at least one high dynamic range picture from a coded bistream, said apparatus comprising a processor configured to:
decode a standard dynamic range picture from said coded bistream,
decode at least one pivot point by decoding the components of said at least one pivot point, said at least one decoded pivot point being representative of an adjustment function comprising at least one linear segment, said at least one decoded pivot point defining the beginning or the end of a linear segment and comprising at least two components defining a spatial location of said decoded pivot point,
reconstruct a scalar integer by:
selecting at least one pivot point according to a criterion from said at least one decoded pivot point;
decoding at least one bit of a binary representation of said scalar value from a least significant bit of a component of at least one selected pivot point;
reconstructing said scalar value from said at least one decoded bit of said binary representation;
determine a corrected colour correction function from a colour correction function adjusted by said adjustment function;
modify a luminance component of said decoded standard dynamic range picture using said reconstructed scalar value;
modify chrominance components of said decoded standard dynamic range picture using said corrected colour correction function; and
reconstruct said high dynamic range picture from said modified luminance component and chrominance components of said decoded standard dynamic range picture.

48. A computer program comprising software code instructions for performing the method according to claim 1, when the computer program is executed by a processor.

49. A bitstream representative of at least one coded high dynamic range picture comprising:
coded data representative of at least one standard dynamic range picture obtained from said high dynamic range picture,
coded data representative of:
at least pivot point defining the beginning or the end of a linear segment of an adjustment function comprising at least one linear segment, a pivot point comprising at least two components defining a spatial location of said pivot point, said adjustment function being used to adjust a colour correction function, said adjusted colour correction function being used for modifying the chrominance components of said decoded standard dynamic range picture when reconstructing said high dynamic range picture;
a scalar value used to modify the luminance component of said decoded standard dynamic range picture when reconstructing said high dynamic range picture;
wherein each bit of a binary representation of said scalar value is coded in a least significant bit of a component of at least one of said pivot points.
